(19) United States
(12) Patent Application Publication
(10) Pub. No.: US 2011/0314181 A1
(43) Pub. Date: Dec. 22, 2011

(54) METHOD, APPARATUS AND SYSTEM FOR ADVERTISING NETWORK ADDRESS TRANSLATION DEVICE INFORMATION

(75) Inventor: Dayong GUO, Beijing (CN)

(73) Assignee: Huawei Technologies Co., Ltd., Shenzhen (CN)

(21) Appl. No.: 13/218,675

(22) Filed: Aug. 26, 2011

Related U.S. Application Data
(63) Continuation of application No. PCT/CN2009/076060, filed on Dec. 25, 2009.

(30) Foreign Application Priority Data
Feb. 28, 2009 (CN) 200910105680.2

(51) Int. Cl. G06F 15/16

(52) U.S. Cl. 709/245

(57) ABSTRACT

In the field of communications technologies, a method for advertising Network Address Translation (NAT) device information is provided, so as to solve a problem in the prior art that a process for finding an NAT device is complex, and that the NAT device information acquired is limited. The method provides a packet carrying the NAT device information for a node in a private network to which the NAT device belongs by carrying the NAT device information in the packet. The method not only enables the nodes in the private network to find the NAT device, but also enables the nodes in the private network to acquire related information of the NAT device. An apparatus and a system for advertising NAT device information are also provided.

### CROSS-REFERENCE TO RELATED APPLICATIONS

This application is a continuation of International Application No. PCT/CN2009/076060, filed on Dec. 25, 2009, which claims priority to Chinese Patent Application No. 200910105680.2, filed on Feb. 28, 2009, both of which are hereby incorporated by reference in their entireties.

### FIELD OF THE INVENTION

The present invention relates to the field of communications technologies, and in particular, to a method, an apparatus and a system for advertising Network Address Translation (NAT) device information.

### BACKGROUND OF THE INVENTION

NAT/NAPT (Network Address Translation/Network Address Port Translation), referred to as NAT in the following, is a technology introduced in 1990s when Internet was developing rapidly, so as to solve a shortage problem of Internet Protocol (IP) addresses. By deploying an NAT device at an edge of a network that uses private network addresses, address information carried in a packet header is translated, so that nodes in the private network may access a public network. Apart from translating private network addresses and public network addresses, NAT may be further used for translation of Internet Protocol version 4 (IPv4) and Internet Protocol version 6 (IPv6) addresses.

The NAT technology effectively improves utilization efficiency of network addresses, and decreases a consumption rate of the IPv4 addresses. Moreover, NAT only supports one-way initiation of session connection, and nodes in the public network may not actively communicate with the nodes in the private network directly. Therefore, using NAT may secure the private network.

However, while improving the security, NAT also impedes deployment of applications. As a part of the applications also needs to carry address information in a payload of a packet, when the packet passes through NAT, the address information carried in the payload needs to be translated, which requires special processing for a specific application. NAT seriously affects the deployment of such an application. Secondly, two devices behind NAT may not communicate directly either, because a device behind NAT is neither aware of the existence of NAT, nor aware of public network addresses used by the device.

In order to realize NAT traversal, the prior art provides solutions of Simple Traversal of User Datagram Protocol (UDP) Through NAT (STUN) and Traversal Using Relay NAT (TURN). STUN and TURN require a special server deployed in the public network. The node in the private network needs to perform repeated information exchange with the server to acquire a public network address of the node in the private network, so as to realize the NAT traversal.

During the implementation of the present invention, a disadvantage is found: because STUN and TURN are only a method and are not defined as a protocol specifically, at present, each application protocol adopts the method independently; therefore, an implementation cost is still high.

### SUMMARY OF THE INVENTION

Accordingly, embodiments of the present invention provide a method, an apparatus and a system for advertising NAT device information.

A method for advertising NAT device information includes:

carrying NAT device information in a packet; and

providing the packet carrying the NAT device information for a node in a private network to which an NAT device belongs.

An apparatus for advertising NAT device information includes:

an information module, configured to insert the NAT device information into a packet, so that the packet carries the NAT device information; and

a sending module, configured to send the packet carrying the NAT device information and provide the packet for a node in a private network to which the NAT device belongs.

A system for advertising NAT device information includes:

at least one NAT device, configured to insert the NAT device information into a packet, and provide the packet carrying the NAT device information for a network device in a private network to which the NAT device belongs; and

at least one network device, located in the private network to which the NAT device belongs, and configured to acquire the NAT device information according to a received packet carrying the NAT device information.

According to the embodiments of the present invention, not only the nodes in the private network are enabled to find the NAT device, but also the nodes in the private network are enabled to acquire related information of the NAT device.

### BRIEF DESCRIPTION OF THE DRAWINGS

FIG. 1 is a flow chart of a method for advertising NAT device information according to an embodiment of the present invention;

FIG. 2 is a schematic structural diagram of an apparatus for advertising NAT device information according to another embodiment of the present invention;

FIG. 3 is a schematic structural diagram of an information module 200 in an apparatus for advertising NAT device information according to another embodiment of the present invention;

FIG. 4 is a schematic structural diagram of an information module 200 in an apparatus for advertising NAT device information according to another embodiment of the present invention;

FIG. 5 is a schematic structural diagram of a sending module 210 in an apparatus for advertising NAT device information according to another embodiment of the present invention;

FIG. 6 is a schematic structural diagram of a system for advertising NAT device information according to further another embodiment of the present invention;

FIG. 7 is a schematic diagram of a format of an Open Shortest Path First (OSPF) Router Information Link State Advertisement (LSA) in an application scenario according to an embodiment of the present invention; and

FIG. 8 is a schematic diagram of a format of a sub-Type-Length-Value (sub-TLV) of an OSPF Router Information LSA in an application scenario according to an embodiment of the present invention.

### DETAILED DESCRIPTION OF THE EMBODIMENTS

In order to make the objectives, technical solutions and advantages of the embodiments of the present invention clearer, the embodiments of the present invention are hereinafter described in detail with reference to the accompanying drawings.

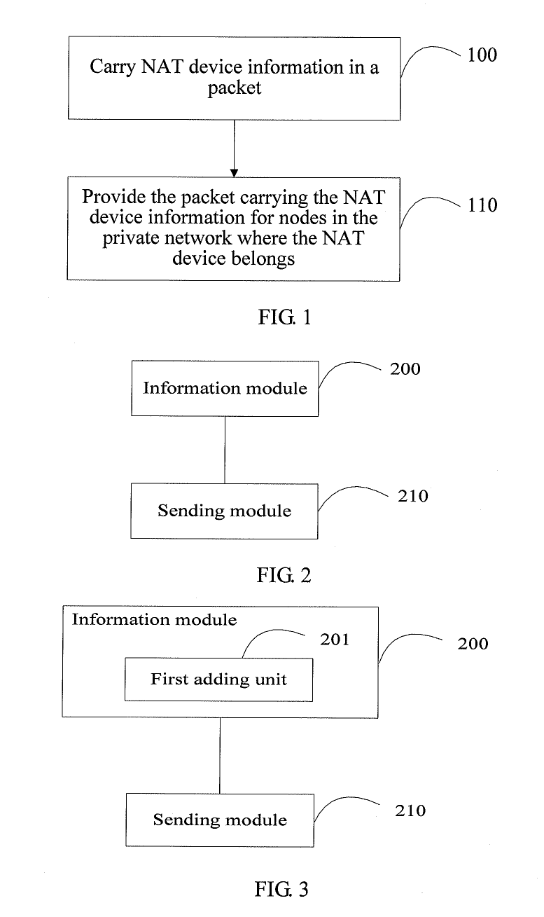

As shown in FIG. 1, FIG. 1 is a flow chart of a method for advertising NAT device information according to an embodiment of the present invention, and the method includes the following steps:

Step 100: Carry NAT device information in a packet.

In the embodiment, the packet may be a Dynamic Host Configuration Protocol (DHCP) packet, or may be an Interior Gateway Protocol (IGP) packet such as an OSPF protocol packet, an Intermediate System to Intermediate Systems (ISIS) protocol packet, or a Routing Information Protocol (RIP) packet. Definitely, the packet in the embodiment may also be a Router Advertisement (RA) packet in IPv6. When the NAT device information is inserted into the packets, the packets carry the NAT device information.

The NAT device information may be address information of an NAT device, for example, an address used by the NAT device to communicate with other nodes in a private network to which the NAT device belongs. Through the address information, network nodes may find the NAT device in the network. Definitely, apart from the address information of the NAT device, optionally, the NAT device information may also include at least one type of the following information: capability information of the NAT device and attribute information of the NAT device.

The capability information of the NAT device may be one or more types of the following information:

(a) An IP address version supported by the NAT device. The information may indicate whether the NAT device supports an IPv4 address version or an IPv6 address version, or supports the IPv4 version and the IPv6 version at the same time.

(b) Whether the NAT device supports an address unnumbered. The information may indicate whether the NAT device allows a node in the private network to which the NAT device belongs to use a public network address and a port range of the NAT device.

(c) Whether the NAT device is allowed to communicate with other network nodes. The information may indicate whether network nodes are allowed to further communicate with the NAT device to acquire more information or manage NAT.

The attribute information of the NAT device may be one or more types of the following information:

(d) Type information of the NAT device. The information may indicate the type information of the NAT device, and common types of the NAT device, for example, include: symmetric NAT, port restricted cone NAT, address restricted cone NAT, and full cone NAT.

(e) Use priority of the NAT device. The information may indicate the use priority of NAT devices when multiple NAT devices exist, and normally a network device in the private network preferentially uses an NAT device with a high priority.

(f) An aging time of dynamic address mapping between a private network address and a public network address in the NAT device. The information may indicate a maximum duration of dynamic address mapping information in the NAT device when no packet passes.

(g) A private network address pool range of the NAT device. The information may indicate addresses that may be used by the private network to which the NAT device belongs, for example 192.168.1.0/24.

(h) A public network address pool range of the NAT device. The information may indicate a public network address and address segments used by the NAT device, for example 64.1.1.0/24.

Step 110: Provide the packet carrying the NAT device information for nodes in a private network to which the NAT device belongs.

In the embodiment, providing the packet carrying the NAT device information for the nodes in the private network to which the NAT device belongs may be implemented by flooding the packet carrying the NAT device information in the private network to which the NAT device belongs, for example, flooding an OSPF packet carrying the NAT device information in the private network; or may be implemented by sending the packet carrying the NAT device information to the nodes in the private network by unicasting, for example, sending a DHCP packet carrying the NAT device information to the nodes in the private network by unicasting, so that the node in the private network may acquire the NAT device information. Definitely alternatively, the providing the packet carrying the NAT device information for the nodes in the private network to which the NAT device belongs may also be implemented in other manners. For example, if in the private network to which the NAT device belongs, the private network addresses of the nodes only have one network segment, the providing the packet carrying the NAT device information for the nodes in the private network to which the NAT device belongs may be implemented by broadcasting the packet carrying the NAT device information in the private network to which the NAT device belongs.

The nodes in the private network to which the NAT device belongs may acquire the NAT device information by receiving the packet carrying the NAT device information. For example, when the packet carries the address information and capability information of the NAT device, the nodes in the private network to which the NAT device belongs may use the acquired information to find the NAT device, and further communicate with the NAT device to acquire information such as external addresses of network nodes in the private network. When the packet carries the attribute information of the NAT device, the nodes in the private network to which the NAT device belongs may know basic characteristics of the NAT device through the information, and as a result further optimize some application protocols. For example, in applications such as Peer to Peer (P2P), after knowing the type information of the NAT device, the nodes in the private network may decide whether to choose direct communication between the peers or communication between the peers through relay of a super node. In another example, if the aging time of the dynamic address mapping between the private addresses and public addresses in the NAT device is known, an appropriate sending interval of a keep alive packet may be selected.

In the embodiment, the nodes in the private network may be a router, a customer border gateway, a Customer Premises Equipment (CPE), or a terminal device.

In general cases, network nodes such as the router, customer border gateway and CPE acquire the NAT device information directly by receiving the packet carrying the NAT device information. The terminal device acquires the NAT device information indirectly from the above network nodes through router advertisement information or the DHCP.

In may be seen that, the method for advertising NAT device information according to the embodiment of the present invention not only enables the nodes in the private network to find the NAT device, but also enables the nodes in the private network to acquire related information of the NAT device, so that the NAT does not impede deployment of applications while improving security. In addition, because two devices behind the NAT may know the existence of the NAT according to the NAT device information advertised in the embodiment, the two devices behind the NAT both may conveniently know public network addresses thereof, and therefore, the two devices behind the NAT may communicate with each other conveniently. Eventually, the method of the embodiment may realize NAT traversal with a low cost without deploying a special server.

Another embodiment of the present invention provides an apparatus for advertising NAT device information. As shown in FIG. 2, the apparatus includes:

an information module 200, configured to insert NAT device information into a packet, so that the packet carries the NAT device information; and

a sending module 210, configured to send the packet carrying the NAT device information and provide the packet carrying the NAT device information for a node in a private network to which the NAT device belongs.

Specifically, as shown in FIG. 3, the information module 200 includes:

a first adding unit 201, configured to insert address information of the NAT device into the packet, so that the packet carries the address information of the NAT device.

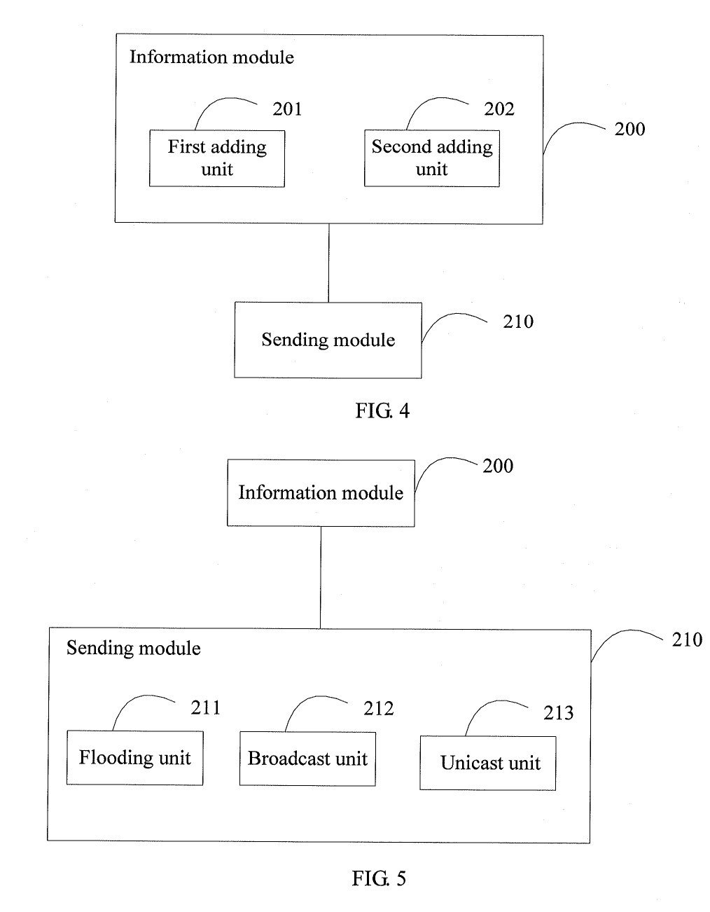

Optionally, as shown in FIG. 4, the information module 200 may further include:

a second adding unit 202, configured to insert capability information and/or attribute information of the NAT device into the packet, so that the packet carries the capability information and/or attribute information of the NAT device.

Optionally, as shown in FIG. 5, the sending module 210 may include one unit or a combination of any units among the following units:

a flooding unit 211, configured to flood the packet carrying the NAT device information in the private network to which the NAT device belongs;

a broadcast unit 212, configured to broadcast the packet carrying the NAT device information in the private network to which the NAT device belongs;

a unicast unit 213, configured to send the packet carrying the NAT device information to the nodes in the private network to which the NAT device belongs by unicasting.

It should be noted that, for the convenience of understanding, FIG. 5 only shows a situation that the sending module 210 includes the flooding unit 211, the broadcast unit 212 and the unicast unit 213 at the same time, and other combination situations are not shown.

In the embodiment of the present invention, the apparatus for advertising the NAT device information may be an independent network device, for example, an independent NAT device or a DHCP server. When the apparatus is a DHCP server, the NAT device information may be pre-configured on the DHCP server. When the DHCP server communicates with a client, the NAT device information may be inserted into a DHCP response packet and sent to the client, so that the client may acquire the NAT device information. In practice, the NAT device and the DHCP server may be the same device. Therefore, in the embodiment of the present invention, the apparatus for advertising the NAT device information may be a device integrating NAT functions and DHCP server functions.

Definitely, in the embodiment of the present invention, the apparatus for advertising the NAT device information may also be a component disposed in a network device, for example, a component disposed in the NAT device, or a component disposed in other network devices.

In may be seen that, the apparatus for advertising NAT device information according to the embodiment of the present invention not only enables the nodes in the private network to find the NAT device, but also enables the nodes in the private network to acquire related information of the NAT device, so that the NAT does not impede deployment of applications while improving security. In addition, because two devices behind the NAT may know the existence of the NAT according to the NAT device information advertised by the apparatus in the embodiment, the two devices behind the NAT both may conveniently know public network addresses thereof, and therefore, the two devices behind the NAT may communicate with each other conveniently. Eventually, the apparatus of the embodiment may realize NAT traversal with a low cost without deploying a special server.

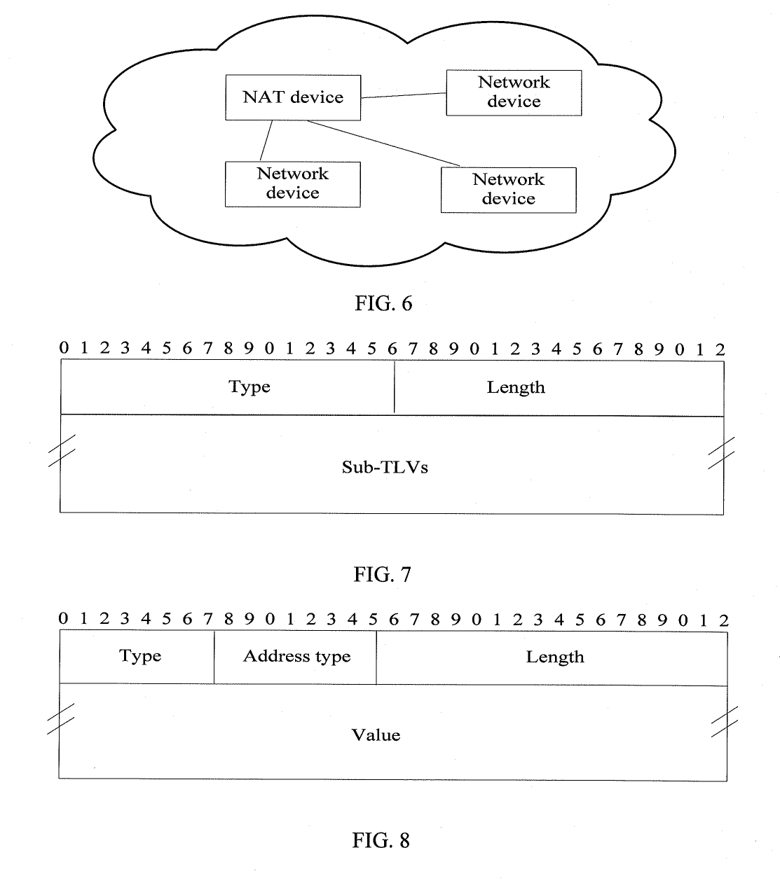

Another embodiment of the present invention provides a system for advertising NAT device information. As shown in FIG. 6, the system includes:

at least one NAT device, configured to insert NAT device information into a packet, and provide the packet carrying the NAT device information for a network device in a private network to which the NAT device belongs.

at least one network device, located in the private network to which the NAT device belongs and configured to acquire the NAT device information according to a received packet carrying the NAT device information.

The system for advertising the NAT device information according to the embodiment of the present invention not only enables the nodes in the private network to find the NAT device, but also enables the nodes in the private network to acquire related information of the NAT device.

In the embodiment of the present invention, carrying the NAT device information in the packet may be multiplexing an existing option/field in the packet to bear the NAT device information, or may be extending the existing option/field in the packet to bear the NAT device information. Definitely, a new option/field may be added in the packet to bear the NAT device information.

For a better understanding of the embodiment of the present invention, a specific application scenario of carrying TLV of the NAT device information by extending a Router Information LSA in an OSFP protocol is described.

In the application scenario, a format of an OSPF Router Information LAS is shown in FIG. 7, where

Type indicates that the TLV is an NAT device information advertisement;

Length indicates a length of sub-TLVs, for example, the number of bits; and

Sub-TLVs are child TLVs, and carry various information of the NAT device that needs to be advertised, and a format thereof may be as shown in FIG. 8, where:

Type indicates a type of information of the NAT device that the sub-TLV advertises;

Address-Type indicates an IP address version of the Value of the sub-TLV, and different values may be used to represent different IP address versions;

Length indicates a length of Value; and

Value is the NAT device information.

When the Value is the address information of the NAT device, which may be an IPv4 address or an IPv6 address according to specification of Address-Type. This part may carry one IP address or carry multiple IP addresses which are generally IP addresses of the same type.

When the Value is the capability information of the NAT device, each bit may be used to represent a capability of the NAT device, for example, a private network IP address version supported by the NAT device, a public network IP address version supported by the NAT device, and whether the NAT device supports a Carrier Grade NAT (CGN) function.

When the Value is the attribute information of the NAT device, a fixed format similar to the one used for indicating the capability information of the NAT device may be used to indicate various attribute information of the NAT device; definitely, according to an actual situation, different formats may be used flexibly to indicate different attribute information of the NAT device.

It should be understood that, in the embodiment of the present invention, the OSPF Router Information LSA may have one sub-TLV, or have multiple sub-TLVs.

In can be seen that, the system for advertising NAT device information according to the embodiment of the present invention not only enables a network device in the private network to find the NAT device, but also enables the network device in the private network to acquire related information of the NAT device, so that the NAT does not impede deployment of applications while improving security. In addition, because two network devices behind the NAT may know the existence of the NAT according to the NAT device information provided by the NAT device in the embodiment, the two network devices behind the NAT in the private network may conveniently know public network addresses thereof, and therefore, the two network devices behind the NAT in the private network may communicate with each other conveniently. Eventually, the system of the embodiment may realize NAT traversal with a low cost without deploying a special server.

Through the description of the above embodiments, it is clearly understood by persons skilled in the art that the present invention may be accomplished through software plus a necessary universal hardware platform, or through hardware. Based on this and erstanding, the technical solutions of the present invention may be embodied in the form of a software product. The computer software product may be stored in a storage medium such as a Read Only Memory (ROM)/a Random Access Memory (RAM), a magnetic disk, or an optical disk and contain several instructions adapted to instruct a computer equipment, or a server, or other network devices to perform the method according to the embodiments or a part of the embodiments of the present invention.

The above embodiments are merely exemplary embodiments of the present invention, and are not intended to limit the protection scope of the present invention. Any modifications, equivalent replacements or improvements made without departing the spirit and principle of the present invention shall fall within the protection scope of the present invention.

1. A method for advertising Network Address Translation (NAT) device information, comprising:
carrying the NAT device information in a packet; and
providing the packet carrying the NAT device information for a node in a private network to which the NAT device belongs.

2. The method according to claim 1, wherein the packet is one of a Dynamic Host Configuration Protocol (DHCP) packet, an Interior Gateway Protocol (IGP) packet or a Router Advertisement (RA) packet;
the IGP packet comprises one of: an Open Shortest Path First (OSPF) protocol packet, an Intermediate System to Intermediate Systems (ISIS) protocol packet, or a Routing Information Protocol (RIP) packet.

3. The method according to claim 1, wherein the NAT device information comprises one of: address information of the NAT device.

4. The method according to claim 3, wherein the NAT device information further comprises at least one type of the following information: capability information of the NAT device and attribute information of the NAT device; wherein
the capability information of the NAT device comprises at least one type of the following information: Internet Protocol (IP) address version supported by the NAT device, whether the NAT device supports an address unnumbered, whether the NAT device is allowed to communicate with other network nodes; and
the attribute information of the NAT device comprises at least one type of the following information: type information of the NAT device, priority of the NAT device, an aging time of dynamic address mapping between a private network address and a public network address in the NAT device, a private network address pool range of the NAT device, and a public network address pool range of the NAT device.

5. The method according to claim 1, wherein the providing the packet carrying the NAT device information for the nodes in the private network to which the NAT device belongs comprises one of:
flooding the packet carrying the NAT device information in the private network to which the NAT device belongs; or
broadcasting the packet carrying the NAT device information in the private network to which the NAT device belongs; or
sending the packet carrying the NAT device information to the nodes in the private network to which the NAT device belongs by unicasting.

6. An apparatus for advertising Network Address Translation (NAT) device information, comprising:
an information module, configured to insert the NAT device information into a packet, so that the packet carries the NAT device information; and
a sending module, configured to send the packet carrying the NAT device information and provide the packet for a node in a private network to which the NAT device belongs.

7. The apparatus according to claim 6, wherein the information module comprises:
a first adding unit, configured to insert address information of the NAT device into the packet, so that the packet carries the address information of the NAT device.

8. The apparatus according to claim 7, wherein the information module further comprises:
a second adding unit, configured to insert capability information and/or attribute information of the NAT device into the packet, so that the packet carries the capability information and/or attribute information of the NAT device.

9. The apparatus according to claim 6, wherein the sending module comprises anyone of the following units:
a flooding unit, configured to flood the packet carrying the NAT device information in the private network to which the NAT device belongs; or
a broadcast unit, configured to broadcast the packet carrying the NAT device information in the private network to which the NAT device belongs; or
a unicast unit, configured to send the packet carrying the NAT device information to the nodes in the private network to which the NAT device belongs by unicasting.

10. A system for advertising Network Address Translation (NAT) device information, comprising:
at least one NAT device, configured to insert the NAT device information into a packet, and provide the packet carrying the NAT device information for a network device in a private network to which the NAT device belongs; and
at least one network device, located in the private network to which the NAT device belongs and configured to acquire the NAT device information according to the received packet carrying the NAT device information.

11. The system according to claim 10, wherein the NAT device comprises:
an information module, configured to insert the NAT device information into the packet, so that the packet carries the NAT device information; and
a sending module, configured to send the packet carrying the NAT device information and provide the packet for nodes in the private network to which the NAT device belongs.

12. The system according to claim 11, wherein the information module comprises one of:
a first adding unit, configured to insert address information of the NAT device into the packet, so that the packet carries the address information of the NAT device; or
apart from comprising the first adding unit, the information module further comprises:
a second adding unit, configured to insert capability information and/or attribute information of the NAT device into the packet, so that the packet carries the capability information and/or attribute information of the NAT device.

13. The system according to claim 11, wherein the sending module comprises anyone of the following units one of:
a flooding unit, configured to flood the packet carrying the NAT device information in the private network to which the NAT device belongs;
a broadcast unit, configured to broadcast the packet carrying the NAT device information in the private network to which the NAT device belongs; or
a unicast unit, configured to send the packet carrying the NAT device information to the nodes in the private network to which the NAT device belongs by unicasting.
